(19) United States
(12) Patent Application Publication
(10) Pub. No.: US 2021/0098833 A1
(43) Pub. Date: Apr. 1, 2021

(54) MODULAR REMOTE BATTERY PACK

(71) Applicant: POWER.GLOBAL, PBC, Pasadena, CA (US)

(72) Inventor: W. Porter Harris, Pasadena, CA (US)

(21) Appl. No.: 17/021,353

(22) Filed: Sep. 15, 2020

Related U.S. Application Data
(60) Provisional application No. 62/906,634, filed on Sep. 26, 2019.

(51) Int. Cl. H01M 10/42; H01M 10/0525; H01M 10/48; H02J 7/00

(52) U.S. Cl. CPC H01M 10/4257; H01M 10/0525; H01M 10/482; H01M 2010/4278; H02J 7/00032; H02J 7/0029; H02J 7/0016; H02J 7/0047

(57) ABSTRACT

Modular battery pack can have lithium-ion based battery cells and a wireless transmitter and receiver. The modular battery pack is configured to communicate with other modular battery packs. The modular battery packs are configured to connect as nodes that form a mesh communication network to provide a redundant communication path to a remote system from any of the modular battery packs. The remote system can gather data from each of the modular battery packs through the network and communicate with a remote system. Other aspects are described.

### CROSS REFERENCE TO RELATED APPLICATIONS

This application claims priority to pending U.S. Provisional Application No. 62/906,634 filed Sep. 26, 2019.

### TECHNICAL FIELD

Aspects of the disclosure relates to energy storage. In particular, aspects relate to a modular remote battery pack.

### BACKGROUND

Lithium-ion based battery cells have a high energy density and are rechargeable. They are popular fora variety of energy storage applications such as cell phones, laptops, and electric vehicles. These cells require more management than traditional lead-acid batteries due to safety reasons.

### SUMMARY

Lead-acid batteries continue to be popular in applications that require a robust, low-maintenance solution, such as for a utility backup energy storage, or for automotive/transportation use. Owners and users of lead-acid battery packs might not have the technical knowledge or tools necessary to properly manage and maintain a battery pack comprised of lithium ion batteries. Therefore, a lithium ion battery pack having a reliable network connection to a remote control system can help offload management tasks and provide an added layer of safety to the owner or user of the lithium ion battery pack.

In one aspect of the present disclosure, a lithium-ion based battery can have a plurality of cells managed by embedded electronics for switching the cells in and out of circuit, internal data storage, voltage, current and temperature protection, over the air updates, remote on/off of the battery, and wireless data transfer to cloud based server for analysis and real-time operational changes.

Such a battery system can provide additional support infrastructure for managing the lithium ion battery health and prolonging battery life. In addition, such infrastructure can provide a platform and interface to allow for management and leasing of batteries to users remotely. Each leased battery can be remotely managed and supported throughout the battery pack's life, thus promoting entry of the battery product to market.

Existing battery packs are managed locally by local electronics such as a programmed processor, sensors, and electronic switching mechanisms (e.g., relays and/or semi-conductors). Even in the case where a battery pack can connect to a network (e.g., wirelessly or through a wired connection), a single application can often require multiple battery packs. Further, a single user may have multiple battery packs designated for different applications (e.g., one to power a garage, another to provide backup power to an inverter, etc.). Some battery packs may be able to communicate to the network while others cannot.

In one aspect of the present disclosure, each battery pack can be a node that connects with another alike battery pack to form a mesh network, thereby providing redundancy to generate a more reliable communication between a remote system and a battery, and provide improved communication between battery packs. Strong communication between batteries and a remote management system can provide a hands-off modular system that can be remotely managed. This can help users replace traditional lead-acid batteries, which tend to be low-maintenance due to their robustness and tolerance to different conditions (e.g., cell imbalance, temperature, etc.), with lithium-ion based batteries, which have higher energy density.

In one aspect, a battery system (e.g., a modular battery pack) can have one or more lithium ion batteries, and a wireless transmitter and receiver. The battery system includes a controller in communication with the wireless transmitter and receiver. The controller can be configured to perform operations that include: communicating with a second battery system. Batteries can automatically communicate and connect as nodes when they are within wireless range.

The connected batteries can behave as nodes that form a mesh network, providing redundant communications between any of the connected battery systems and a remote management system. This mesh can provide a reliable and redundant communication path, as well as reducing bandwidth that would otherwise be generated if each battery pack communicated with the remote system individually. Other aspects are described.

The above summary does not include an exhaustive list of all embodiments of the present disclosure. It is contemplated that the disclosure includes all systems and methods that can be practiced from all suitable combinations of the various embodiments summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several embodiments of the disclosure here are illustrated byway of example and not by way of limitation in the figures of the accompanying drawings in which like references indicate similar elements. It should be noted that references to “an” or “one” embodiment in this disclosure are not necessarily to the same embodiment, and they mean at least one. Also, in the interest of conciseness and reducing the total number of figures, a given figure may be used to illustrate the features of more than one embodiment of the disclosure, and not all elements in the figure may be required fora given embodiment.

FIG. 1 shows a battery system according to one aspect.

FIGS. 2-3 shows a battery system in connection with other alike battery systems, according to aspects.

FIG. 4 shows a battery system in connection with other alike battery systems and a remote system, over power line communications and wireless communications, according to one aspect.

FIG. 5 shows a battery system in connection with other alike battery systems and a remote system over wireless communication, according to one aspect.

FIGS. 6-7 shows a battery system in connection with other alike battery systems and a remote system, over power line communications and wireless communications, according to one aspect.

FIG. 8 shows a battery system mesh network isolated by user.

FIG. 9 shows a battery system mesh network shared by a user.

### DETAILED DESCRIPTION

Several embodiments of the disclosure with reference to the appended drawings are now explained. Whenever the shapes, relative positions and other embodiments of the parts described are not explicitly defined, the scope of the invention is not limited only to the parts shown, which are meant merely for the purpose of illustration. Also, while numerous details are set forth, it is understood that some embodiments of the disclosure may be practiced without these details. In other instances, well-known structures, and techniques have not been shown in detail so as not to obscure the understanding of this description.

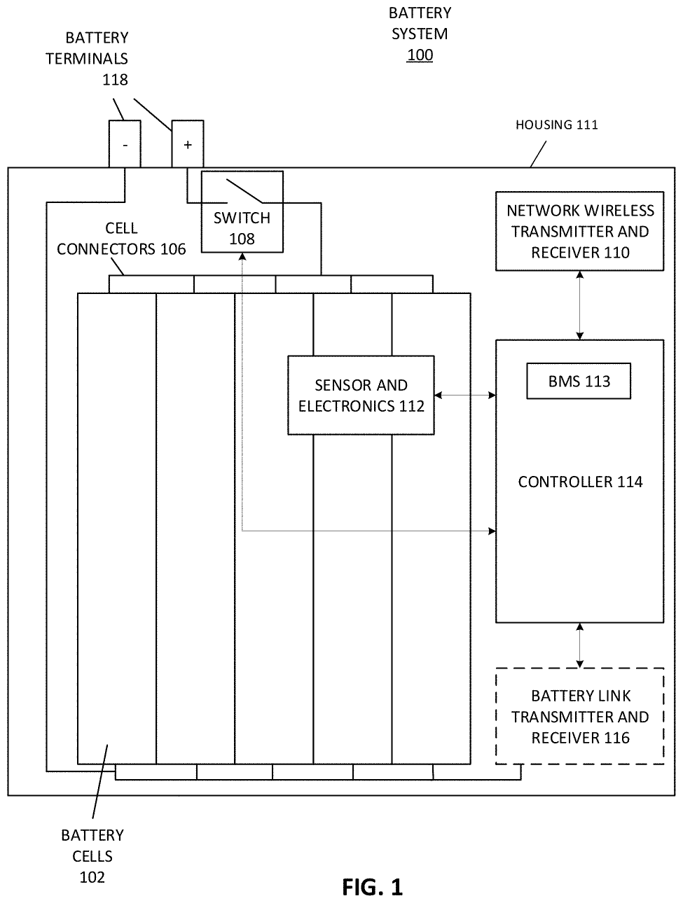

A battery system 100 is shown in FIG. 1, according to one aspect. The battery system (e.g., a battery pack) can have one or more lithium ion battery cells 102. The cells can be connected by cell connectors 106. Cell connectors 106 can include bus bars, wires, printed circuit boards, terminals, and/or other connecting hardware. The cells can be electrically connected in series and/or in parallel, in different configurations that vary based on application. For example, one version of the battery system 100 can have the cells connected in series in a manner that nominally creates a 24V or 48V battery system, when read at terminals 118. The cells can additionally be connected in parallel to provide a specific energy capacity. Such a configuration can be application dependent and determined based on test and repetition.

In one aspect, each battery cell 102 can be a cylindrical lithium-ion rechargeable cell in standard battery package of AA, AAA, 18650, 20700, 21700, or other standard cell geometry. Each cell can have a nominal voltage of 3.6-3.7 volts. The battery cells can have other form factors such as rectangular flat cells. The type of cells used can also be Lithium-Ion, Lithium-polymer, Lithium-Iron, Phosphate, or equivalent cell types.

The system includes a wireless transmitter and receiver 110 that can communicate wirelessly to a remote system. The wireless transmitter and receiver can hardware (e.g., antennae, processors, memory) and/or software that supports communication of Wi-Fi, 4G LTE, 4G, 3G, GSM, 2G, 5G, IrDA or other wireless communication protocols. It should be understood that, for the purpose of the disclosure, a transmitter and receiver can be formed as an integrated solution and/or share hardware and software components. Thus, a transmitter and receiver can also be a transceiver.

The system can a battery link transmitter and receiver 116 that facilitates communication between battery systems. In one aspect, the battery link transmitter and receiver, can be a power line transmitter and receiver that communicates data between battery systems over power lines (e.g., through battery cell connectors 106 and battery terminals 118. Alternatively, or additionally, the battery link transmitter and receiver 116 can have a wireless communication transmitter and receiver that communicates over a local wireless network (e.g., ZigBee, Bluetooth, Wi-Fi, etc.). Additionally, or alternatively, the battery link transmitter and receiver and network wireless transmitter and receiver is integrated such that each battery can communicate with each other over the same hardware and software protocols described above with regard to the network wireless transmitter and receiver 110. In other words, the network wireless transmitter and receiver 110 can also be used to communicate between batteries, wirelessly.

A controller 114 is connected in communication with the wireless transmitter and receiver and the battery link transmitter and receiver, as well as sensors and electronics 112. Sensors and electronics can include known power circuits that utilize solid state switching or relays to isolate, bypass, and/or balance individual cells. The circuits can also include a switch 108 (which can be formed from a semi-conductor, electromechanical relay, or an arrangement thereof) that can isolate or turn off the battery system.

Sensors can include one or more current sensors, voltage sensors, and temperature sensors measured at the cell and/or pack level. Protection circuitry (e.g., various integrated circuits that are available off the shelf) can determine undercharge or overcharge, temperature, medium current and time, and high currents within the battery system. Similarly, the electronics can include a cell balancing circuit that can bypass currents at ⅛ the capacity of a cell.

The controller can include a battery management system (BMS) controller 113 that determines overall battery control, state of charge (SOC), state of health (SOH) of the battery, and state of power (SOP) of the battery through known SOC, SOH, and SOP algorithms. The controller can also perform higher level control and management, data management (e.g., data acquisition and communication of data), wireless communication, and over the air (OTA) software updates.

The controller can include one or more processors, memory, communication buses, and hardware and software facilitating I/O such as but not limited to analog to digital converters and digital to analog converters. The controller can be configured to perform operations that include: communicating with a second battery system over wirelessly, or over power line communications. In some aspects, batteries can communicate when coupled together electrically. The controller can communicate with a remote system to receive a control command from the remote system.

The battery system can have a battery housing 111. The housing can include an enclosure that encloses the battery cells, and the other components shown in FIG. 1 such as the controller, transmitters and receivers. In another aspect, the components can be located at an exterior of the housing. In another aspect, the housing can be open, providing a structural member to connect the battery cells and various components, but otherwise open to the environment. The exact geometry and configuration of the housing can vary based on application.

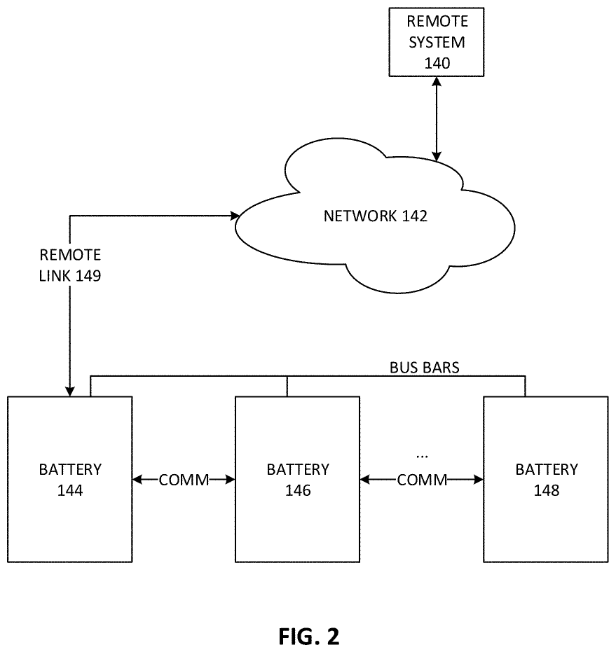

In one aspect, the communicating between battery systems includes determining which battery system should communicate with the remote system. For example, FIG. 2 shows a battery system 144, battery system 146, and battery system 148. Battery 144 can communicate with batteries 146 and 148 to determine which battery system has a stronger signal strength in communicating with the remote system 140 (e.g., through network 142). Various factors can determine which battery has the stronger signal strength such as, but not limited to, location of each battery, or objects such as walls, buildings, furniture, or electronic noise in the environment. In this case, after the batteries communicate with each other their signal strengths, then the battery with the strongest signal strength be designated as the point of contact between the batteries and the remote system 140. The controller of the battery system with the strongest connection can relay communication between the other battery systems and the remote system. The battery system and the second battery system form a mesh communication network to provide a redundant communication path to the remote system from either the battery system or the second battery system.

The designated battery, in this case, battery 144, can communicate over the wireless transmitter and receiver to the remote system, one or more of the following: a voltage, a current, a usage profile, a fault, a battery identifier, a state of charge, a state of health, a state of power, or a battery role, of any or all of the battery systems 144, 146, and 148. The information of battery systems 146 and 148 can be communicated to battery system 144 over the battery link, which can be wireless, or over power line communications, if the batteries are electrically coupled together. This information is then relayed from battery 144 over the network to the remote system 140. Remote system 140 can be a server, a desktop or laptop computer, a mobile device such as a phone, a computer tablet, or other known computing device.

In one aspect, the battery systems arbitrate which battery will assume a particular role, for example, point of contact, or master. As discussed, point of contact can be arbitrated based on signal strength with respect to a network (e.g., a Wi-Fi connection or cell tower) and/or a remote control system. The point of contact and path of communication from a battery to the network can be determined based on network protocol (e.g., dynamic routing protocol).

In another aspect, the battery systems can arbitrate over which battery shall assume a role of master and which shall assume a role of slave. The battery system named ‘master’ can dictate commands to the other battery systems, for example, whether or not to disconnect from the grid. for the for the battery system or for the second battery system. The arbitration can be communicated wirelessly or through power line communication.

In one aspect, the role is arbitrated between the battery systems based on an identifier of each battery system, a connection strength of communication with the remote system, a state of charge, or fault condition. For example, the master/slave role can be arbitrated based on which battery system has a highest or lowest unique serial number. In another aspect, if the battery system designated as master takes on a fault condition, for example, over-temperature, this can indicate an issue with the battery that might cause the battery to fall off-line. In such a case, the batteries can re-arbitrate which shall assume role of master and which shall assume role of slave.

For example, if battery 144 was assigned role of master, but then came under fault, then the roles can be re-arbitrated, but battery 144 shall be ineligible for master due to the fault condition. Battery 148 and 146 can then decide, between the two of them, which shall be assigned master. When batteries arbitrate for role of master and slave, only one battery takes on role of master, and the remaining batteries take on role of slave. The master issues commands to slave batteries.

In one aspect, a battery obeys commands that are given to them by a master battery, but not a slave battery. Commands can include a request for data, a reset command, and an on/off command that causes a slave battery to disconnect itself electrically from a load. Other commands can also be given. In one aspect, the master is also the point of contact between the batteries and the remote system 140. In this manner, the master can receive input from a remote system, then communicate commands to slave battery systems based on the input from the remote system.

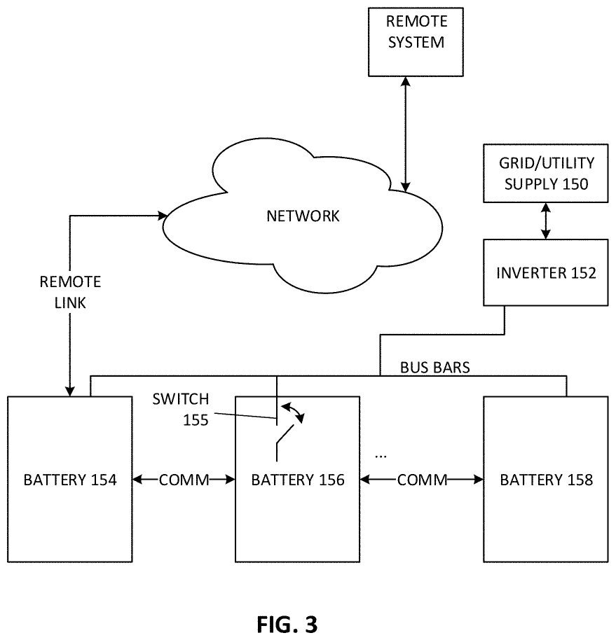

In one aspect, a control command from the remote system includes one or more of the following: a connect command, a disconnect command, a role assignment, a request for battery health information, a request for usage profile, or a request for state of charge. For example, referring now to FIG. 3, a remote system can send a control command to battery 156 through communication with battery 154. Battery 156 can respond to the connect command by closing a switch 155 (thereby connecting the battery cells to output battery terminals), and respond to a disconnect command, by opening the switch (thereby disconnecting the battery cells from output terminals). This can decouple the battery from a source and/or load (e.g., an inverter 152, a vehicle, etc.). In some cases, the batteries can disconnect themselves to reduce leakage current, but when needed, can connect themselves. For example, the inverter can be connected to a grid or utility 150 that can be used to charge the connected batteries. In addition, the connected batteries can be used to supplement the utility during power loss (e.g., a blackout or brownout).

In one aspect, a disconnect command or connect command is based on the control command from the remote system. Alternatively, or additionally, the disconnect/connect command can be based on user configurable settings stored in memory of the battery system. For example, battery 156 can have settings that cause switch 155 to open and close based on a fault condition or a time of day. In one aspect, the disconnect command or connect command is based on a temperature threshold, a voltage threshold, or a current threshold. In this manner, the battery can isolate itself if it is getting too hot, or if current or voltage is too high or too low.

In one aspect, the battery system is a modular battery pack that can connect and communicate seamlessly with other of the same or alike modular battery packs. In one aspect, the modular battery packs are nodes that form a mesh communication network to provide a redundant communication path to the remote system from any of the modular battery packs in the mesh.

The mesh communication network, formed from the batteries, provides communication from any battery to the network through another battery. In one aspect, each battery acts as a mesh node that talk to each other to share a network connection. Each battery can have a wireless transmitter and receiver to communicate seamlessly with each other. Each battery can be configured to with protocol that defines how to interact with each other. Data packets can travel from one node to another node, hopping wirelessly from one mesh node to the next. The nodes can be configured to automatically choose the fastest and most reliable path, e.g., via a dynamic routing protocol. Each node can use a common standard such as, but not limited to Wi-Fi (e.g., 802.11a, b, g), LTE, and 3G.

As more batteries are used and spread in an area, the mesh network grows larger and more reliable. This can be useful where wireless signals are intermittently blocked. The mesh network can be self-configuring and self-healing without requiring a network administrator.

A battery communication link (for example, communication of commands between batteries) and the mesh communication network (for example, data packets that are destined for the network) can occupy different layers. For example, for communication through the mesh communication network, a node can simply resend data packets downstream to another node until the final destination of the data packet is reached, without processing the data in the data packet (so long as the data is not meant for the node to consume). This can help provide redundant communications from each battery to a remote system. Thus, even if one of the batteries is in a location where it cannot communicate with the network (e.g., a wireless router or a cell tower), the battery can still connect the network through one of the other batteries. A remote system can remain in contact with each battery, even if one or more of the batteries loses connection to the network, so long as they remain in communication with each other. In another communication layer, the battery communication link, involves communication (e.g., commands) from one battery to another.

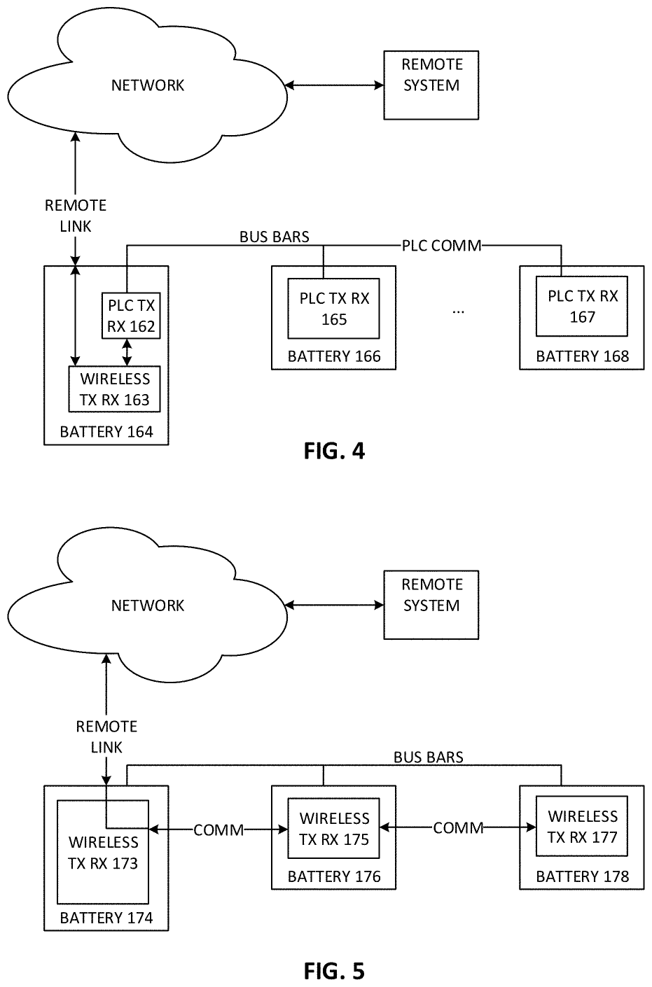

Referring to FIG. 4, the battery communication link (communication of commands and requests between batteries) and the mesh communication network (communication of data packets that hop between batteries as a means to reach a final destination) is formed through communication between respective power line transmitters and receivers 162, 165, and 167 of the respective modular battery packs 164, 166, and 168, each power line communication module having a transmitter and receiver, and associated processing software and hardware to facilitate communication electronically. In order to communicate with the remote system, a wireless communication module 163 of battery 164 connects to the network and can relay information communicated through the mesh connection. Control commands between master and slave batteries can occur over the battery communication link, while communication to and from the remote system can occur over the mesh communication network.

In one aspect, the battery communication link and the mesh communication network informed through communication between respective wireless transmitters and receivers of the modular battery pack and each of the plurality of other modular battery packs. For example, FIG. 5 shows battery packs 174, 176, and 178 connected through wireless modules 173, 175, and 177, each module having a transmitter and receiver, and associated processing software and hardware to facilitate communication electronically.

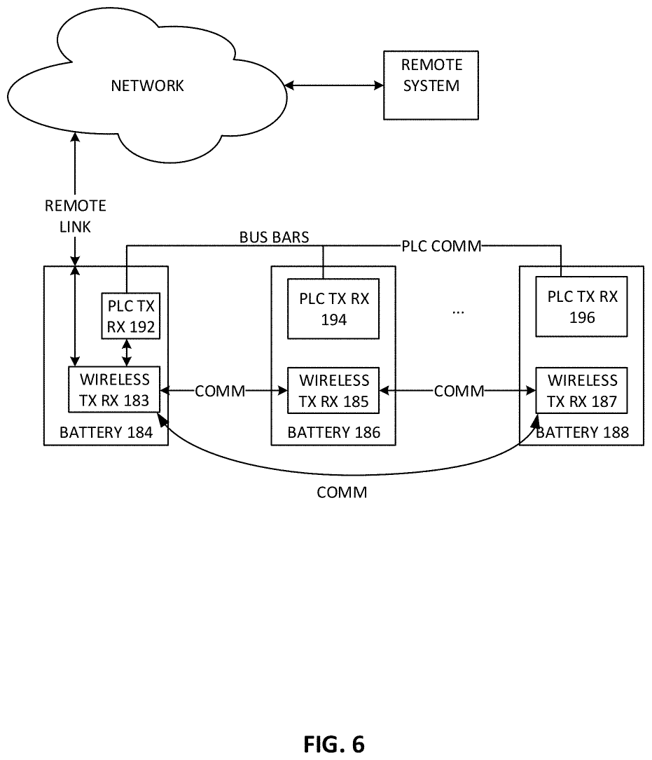

Referring to FIG. 6, in one aspect, the battery communication link is formed through communication between respective power line transmitters and receivers 192, 194, and 196 of the of modular battery packs 184, 186, and 188. The mesh communication network is formed through the respective wireless transmitters and receivers 183, 185, and 187 of the respective modular battery packs. This provides a hybrid approach, using both PLC and wireless communications to provide redundancy in communication.

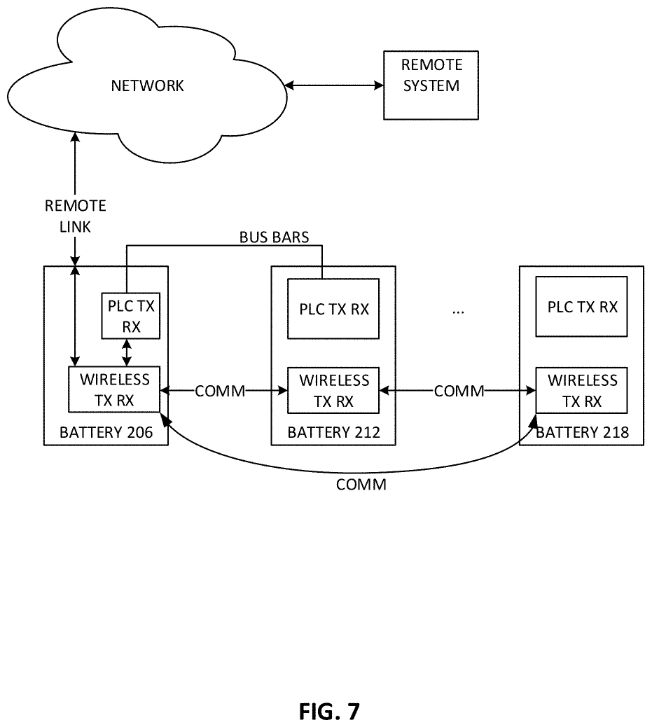

It should be understood that batteries do not have to be electronically coupled together (e.g., through output terminals) in order to form a mesh. For example, FIG. 7 shows battery a battery 218 that is electrically isolated from batteries 206 and 212 that are electrically coupled together. Battery 218, however, can still communicate wirelessly with battery 212 through respective wireless modules to gain access to the network.

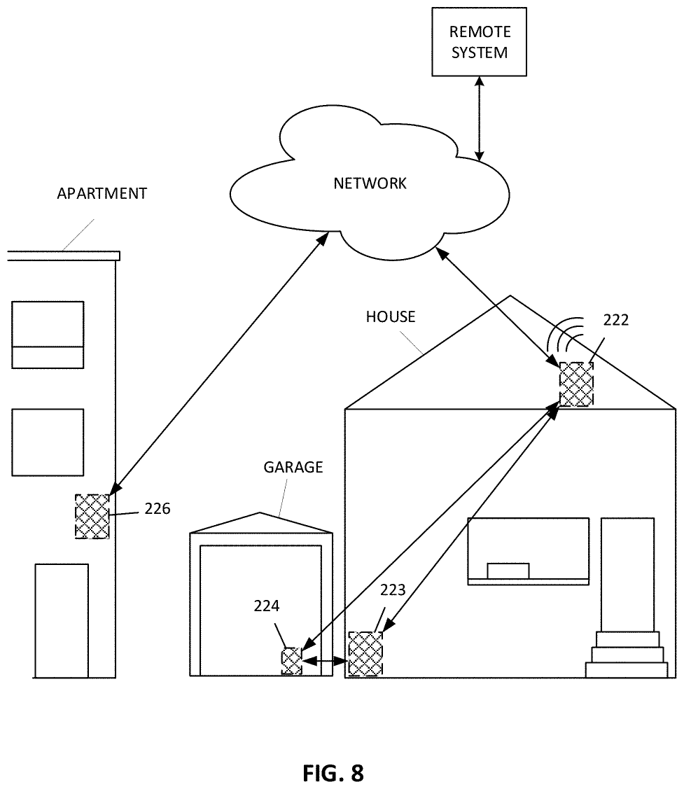

In one aspect, each battery system can be assigned to a user. Referring to FIG. 8, a user can have three battery modules assigned, 222, 223, and 224. A battery module 226 can be assigned to a different user. Assignment can happen through a leasing program, or through purchase. After leased or purchased, the remote system can manage the batteries by retrieving data about the batteries such as fault logs, SOC, SOH, SOP, usage profile, and data discussed in other sections.

Batteries 222, 223, and 224, which are assigned to the first user, can be configured to form a mesh network based on being associated with the same user. In such a case, assuming that battery 222 has the strongest connection with the network, this battery is designated, e.g., through a dynamic routing protocol, as the point of contact for the mesh network formed by batteries 222, 223, 224. Battery 226 would not be part of the same mesh network as batteries 222-224, since this battery is associated with a different user. Batteries 222, 223, and 224 can be configured (for example, through settings, hardware, and/or software) to only form a mesh network with batteries assigned to the same user.

Alternatively, the batteries can be configured to connect with other modular battery packs even if assigned to a different user. The user, in this case, can be given a credit or other reward for sharing network connectivity with other battery holders. This can incentivize network sharing which can beneficially grow the network for batteries in locations where direct connection to a network is limited.

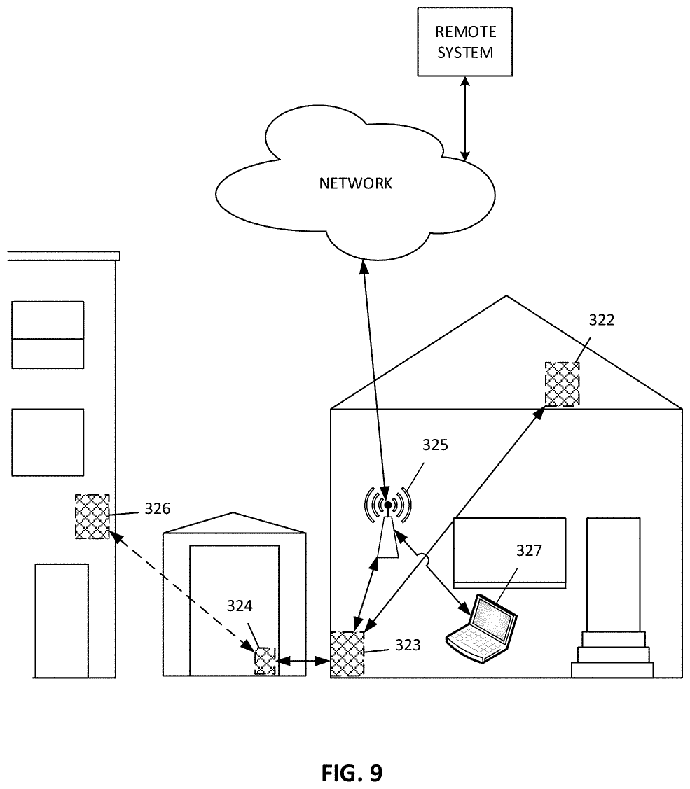

For example, referring to FIG. 9, the battery 326 that is assigned to the second user can have a weak or non-existing connection to the network. In such a case, it can communicate with battery 324 which happens to be nearby in the first user's garage. The first user (who is in care of batteries 322, 323, 324) has agreed to allow battery packs of other users to communicate to the network through the first user's batteries. In other words, the first user has agreed to share her network. Settings in each battery can be configured through the remote system and/or through a local terminal 327 of the user (which can be a laptop, a tablet computer, a mobile phone, etc.). Thus, the second user's battery 326 can communicate to the network through the first user's batteries, through an internet router 325 that is connected through a landline and/or via wireless communication directly to the network (e.g., through a cell tower).

In one aspect, the electronics of the battery system, e.g., the communications modules, sensors, and controllers, are powered by the battery cells local to the battery system. Back-up battery cells apart from the rechargeable cells that connect to the loads and sources can also be employed.

In some aspects, a battery system can utilize infrared based transmitters and receivers (or collectively, infrared transceivers), such as but not limited to, for example, those based on Infrared Data Association (IRDA) standards. Such transceivers can be used for communication between battery packs (e.g., such as those mentioned in FIGS. 1-9), and/or between battery packs and system controllers. For example, battery link transmitter and receiver 116 can include an infrared based transceiver. Remote link 149, wireless TX RX 163, and other communications can use infrared based transceivers. Data rates can range from 115 kbps to 1 Gbps, or greater. Such a system can provide improved security, noise immunity, galvanic isolation and modularity. In some aspects, an enclosure maintains line of sight between battery packs, and/or between a battery pack and a controller. Such a system improves modularity because battery packs can be swapped without disconnecting and reconnecting communications interfaces (e.g., hardware such as electrical or electronic connectors).

In some aspects, one or more networked batteries, as described herein, form infrastructure for providing energy as a service. The modularity, intercommunications, and remote control capabilities allow for batteries to be leased, swapped, monitored, shared, and remotely monitored and controlled (e.g., turned on and off). For example, if a customer fails to meet payment obligations, the battery modules can be remotely turned off (e.g., by a remote system such as a server). Once payment is received, the remote system can turn the battery back then back on. The same communication can be used to monitor users' use habits and update battery configurations, such as, for example, optimizing operating power, voltage, current, thermal limits, and/or set points thereof, based on those users' habits. These settings can be configured to maximize the amount of energy that a battery can provide over the longest time frame possible.

While certain embodiments have been described and shown in the accompanying drawings, it is to be understood that such are merely illustrative of and not restrictive on the broad invention, and that the invention is not limited to the specific constructions and arrangements shown and described, since various other modifications may occur to those of ordinary skill in the art. It should also be understood that while some features are shown in the figures with certain embodiments, those features can be combined with other embodiments described in this disclosure and/or shown in different figures. For example, any of the electrical features discussed can be present in a power pack having a removable grip as well as a power pack that does not have a removable grip.

What is claimed is:

1. A battery system comprising
one or more lithium ion batteries;
a wireless transmitter and receiver; and
a controller in communication with the wireless transmitter and receiver, the controller configured to perform operations that include:
communicating with a second battery system over the wireless transmitter and receiver to connect as nodes that form a mesh communication network to provide a redundant communication path to a remote system from the modular battery pack or any of the plurality of other modular battery packs; and
communicating with a remote system, through the wireless transmitter and receiver, to receive a control command or data from the remote system.

2. The battery system of claim 1, wherein the communicating with the second battery system includes determining which of the battery system or the second battery system should communicate with the remote system.

3. The battery system of claim 2, wherein the determination is based on which of the battery system or the second battery system has a stronger wireless communication connection to the remote system.

4. The battery system of claim 1, wherein the controller is further configured to relay communication between the second battery system and the remote system.

5. The battery system of claim 1, wherein the controller is further configured to communicate over the wireless transmitter and receiver to the remote system, one or more of the following: a voltage, a current, a usage profile, a fault, a battery identifier, a state of charge, or a battery role, of the battery system or the second battery system.

6. The battery system of claim 1, wherein the controller is further configured to arbitrate a role for the battery system or for the second battery system through communication with the second battery system.

7. The battery system of claim 6, wherein the role for the battery system and for the second battery system is arbitrated automatically, without human input.

8. The battery system of claim 7, wherein the role for the battery system and for the second battery system is a master role or a slave role.

9. The battery system of claim 7, wherein the role is arbitrated based on an identifier of the battery system or of the second battery system, a connection strength of communication with the remote system through the wireless transmitter and receiver, a state of charge, or other fault condition.

10. The battery system of claim 1, wherein the controller is configured to disregard a command from the second battery system if the battery system is assigned a master role, and obey the command from the second battery system if the battery system is assigned a slave role.

11. The battery system of claim 1, further comprising a power line communication transmitter and receiver, used to facilitate communication between the battery system and the second battery system.

12. The battery system of claim 1, further comprising a battery housing that houses the one or more lithium ion batteries.

13. The battery system of claim 1, wherein the control command from the remote system includes one or more of the following: a connect command, a disconnect command, a role assignment, a request for battery health information, a request for usage profile, or a request for state of charge.

14. The battery system of claim 13, wherein the controller is further configured to
electrically connect the one or more lithium ion batteries to output battery terminals of the battery system based on the connect command; and
electrically disconnect the one or more lithium ion batteries from the output battery terminals of the battery system based on the disconnect command.

15. The battery system of claim 1, wherein the controller is further configured to communicate to the second battery system, a) a disconnect command to disconnect the one or more batteries of the second battery system from the one or more lithium ion batteries of the battery system or b) a connect command to connect the one or more batteries of the second battery system to the one or more lithium ion batteries of the battery system.

16. The battery system of claim 15, wherein the disconnect command or connect command is based on the control command from the remote system.

17. The battery system of claim 15, wherein the disconnect command or connect command is based on user configurable settings stored in memory of the battery system.

18. The battery system of claim 15, wherein the disconnect command or connect command is based on a temperature threshold, a voltage threshold, or a current threshold.

19. The battery system of claim 1 wherein the wireless transmitter and receiver includes an infrared transmitter and receiver or transceiver.

20. An article of manufacture, comprising:
one or more battery cells;
a wireless transmitter and receiver;
a battery link transmitter and receiver; and
a controller in communication with the wireless transmitter and receiver and the battery link transmitter and receiver,
non-transitory computer-readable memory having stored therein instructions that when executed by a processor of the controller, cause the processor to perform operations, including:
communicating with a second article of manufacture over the battery link transmitter and receiver, when the one or more battery cells of the article of manufacture are connected to one or more battery cells of the second article of manufacture; and
communicating with a remote system to receive a control command from the remote system.

21. A modular battery pack comprising:
one or more battery cells;
a wireless transmitter and receiver; and
a controller in communication with the wireless transmitter and receiver,
non-transitory computer-readable memory having stored therein instructions that when executed by a processor of the controller, cause the processor to perform operations, including:
communicating with a plurality of other modular battery packs over a battery communication link, when the one or more battery cells of the modular battery pack are connected to one or more battery cells of each of the plurality of other modular battery packs; and
communicating with a remote system to receive a control command from the remote system;
wherein the modular battery pack and the plurality of other alike modular battery packs connect as nodes that form a mesh communication network to provide a redundant communication path to the remote system from the modular battery pack or any of the plurality of other modular battery packs.

22. The modular battery pack of claim 21, wherein the battery communication link and the mesh communication network is formed through communication between respective wireless transmitters and receivers of the modular battery pack and each of the plurality of other modular battery packs.

23. The modular battery pack of claim 21, wherein the battery communication link is formed through communication between respective power line transmitters and receivers of the modular battery pack and each of the plurality of other modular battery packs and the mesh communication network is formed through the respective wireless transmitters and receivers of the modular battery pack and each of the plurality of other modular battery packs.

24. The modular battery pack of claim 21, wherein the battery communication link and the mesh communication network is formed through communication between respective power line transmitters and receivers of the modular battery pack and each of the plurality of other modular battery packs.

25. The modular battery pack of claim 21, wherein the wireless transmitter and receiver includes an infrared transmitter and receiver or transceiver.
